(19) United States
(12) Patent Application Publication
(10) Pub. No.: US 2009/0059929 A1
(43) Pub. Date: Mar. 5, 2009

(54) SCHEDULING METHOD AND APPARATUS FOR HIGH SPEED VIDEO STREAM SERVICE IN COMMUNICATION SYSTEM

(75) Inventor: Seung-Hyun LEE, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/200,787

(22) Filed: Aug. 28, 2008

(30) Foreign Application Priority Data
Aug. 28, 2007 (KR) 2007-0086701

(51) Int. Cl. H04L 12/56

(52) U.S. Cl. 370/395.4

(57) ABSTRACT

A scheduling method and apparatus for providing a high speed video stream service in a communication system are provided. The method includes receiving power information for ensuring a minimum data rate from a Radio Network Controller (RNC) through Radio Resource Control (RRC) signaling, receiving power information for a variable data rate from a Node B through scheduling, and performing a high speed video stream service on the basis of the power information received from the RNC and the Node B.

### PRIORITY

This application claims the benefit under 35 U.S.C. §119(a) of a Korean patent application filed in the Korean Intellectual Property Office on Aug. 28, 2007 and assigned Serial No. 2007-86701, the entire disclosure of which is hereby incorporated by reference.

### BACKGROUND OF THE INVENTION

1. Field of the Invention

The present invention relates to a scheduling method and apparatus for a high speed video stream service in a communication system. More particularly, the present invention relates to a scheduling method and apparatus for supporting a variable data rate while ensuring a minimum data rate to provide the high speed video stream service.

2. Description of the Related Art

At present, in a 3^{rd} Generation (3G) wireless communication system such as High Speed Packet Access (HSPA), HSPA evolution, and Long Term Evolution (LTE), services with two different features (e.g., a Voice over Internet Protocol (VoIP) service and a file transfer service) can be provided. The services have different features and are provided in a non-scheduled or scheduled manner.

In the 3G wireless communication system, a delay-sensitive service (e.g., the VoIP service) is provided in a non-scheduled manner while ensuring a constant data rate in every Transmission Time Interval (TTI). As shown in FIG. 1A, when the service is provided in a non-scheduled manner, a Serving Radio Network Controller (SRNC) provides control, and scheduling is performed through Radio Resource Control (RRC) signaling. Therefore, a User Equipment (UE) that uses a VoIP service can transmit an amount of data that is determined through the RRC signaling in every TTI.

Further, in the 3G wireless communication system, a service (e.g., the file transfer service) requiring a high speed data rate that is not sensitive to delay is provided in a scheduled manner. As shown in FIG. 1B, when the service is provided in a scheduled manner, a Node B provides control and allocates a power level (i.e., a grant) to each UE so that scheduled data is controlled. Referring to FIG. 2, the scheduled data is transmitted using a power resource 207 remaining after excluding a power resource 203 for channels other than an Enhanced Uplink Dedicated CHannel (E-DCH) 201 and a power resource 205 for the non-scheduled data.

A real-time video stream service such as video telephony is less sensitive to delay than the VoIP service but is more sensitive to delay than the file transfer service. Further, the real-time video stream service requires a higher data rate than the VoIP service but a lower data rate than the file transfer service. Such a high speed video stream service is provided using conventional Wideband Code Division Multiple Access (WCDMA) channels.

Recently, users of the high speed video stream service are demanding services with higher quality and higher speed. However, it is difficult to satisfy such a user demand because the WCDMA channels have a supportable data rate limit. Thus, the high speed video stream service needs to be provided by using the 3G wireless communication system supporting high quality, high speed services such as the HSPA, the HSPA evolution, and the LTE.

Since the 3G wireless communication system is provided only in a non-scheduled or scheduled manner, there is a need for a scheduling method for providing the high quality, high speed services such as the video stream service.

For the video stream data, a minimum data rate must be guaranteed to transmit a minimum amount of video data, and a data rate which varies according to motion or complexity of a screen must be scheduled. A scheduling method for processing such a data service is not provided in the 3G wireless communication system.

### SUMMARY OF THE INVENTION

An aspect of the present invention is to address at least the above-mentioned problems and/or disadvantages and to provide at least the advantages described below. Accordingly, an aspect of the present invention is to provide a scheduling method and apparatus for a high speed video stream service in a communication system.

Another aspect of the present invention is to provide a scheduling method and apparatus for supporting a variable data rate while ensuring a minimum data rate to provide a high speed video stream service.

In accordance with an aspect of the present invention, a scheduling method of a User Equipment (UE) for providing a high speed video stream service in a communication system is provided. The method includes receiving power information for ensuring a minimum data rate from a Radio Network Controller (RNC) through Radio Resource Control (RRC) signaling, receiving power information for a variable data rate from a Node B through scheduling, and performing a high speed video stream service on the basis of the power information received from the RNC and the Node B.

In accordance with another aspect of the present invention, a scheduling apparatus of a UE for providing a high speed video stream service in a communication system is provided. The apparatus includes a receiver for receiving power information for ensuring a minimum data rate from an RNC through RRC signaling and for receiving power information for a variable data rate from a Node B through scheduling, and an Enhanced-Transport Format Combination (E-TFC) selector for selecting a Transport Format Combination (TFC) for a high speed video stream service on the basis of the power information received from the RNC and the Node B.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1A illustrate conventional non-scheduled data transmission;

FIG. 1B illustrates conventional scheduled data transmission;

FIG. 2 illustrates uplink scheduling in a conventional High Speed Uplink Packet Access (HSUPA) system;

FIGS. 3A and 3B illustrate quasi-scheduled data transmission according to an exemplary embodiment of the present invention;

FIG. 4 illustrates uplink scheduling in a HSUPA system according to an exemplary embodiment of the present invention;

FIG. 5 is a block diagram illustrating a User Equipment (UE) supporting quasi-scheduled data transmission in a HSUPA system according to an exemplary embodiment of the present invention;

FIGS. 6A, 6B, and 6C are flowcharts illustrating an operation of a UE supporting quasi-scheduled data transmission in a HSUPA system according to an exemplary embodiment of the present invention;

FIG. 7 is a block diagram of a Radio Network Controller (RNC) supporting quasi-scheduled data transmission in a HSUPA system according to an exemplary embodiment of the present invention; and

FIG. 8 is a flowchart illustrating an operation of an RNC supporting quasi-scheduled data transmission in a HSUPA system according to an exemplary embodiment of the present invention.

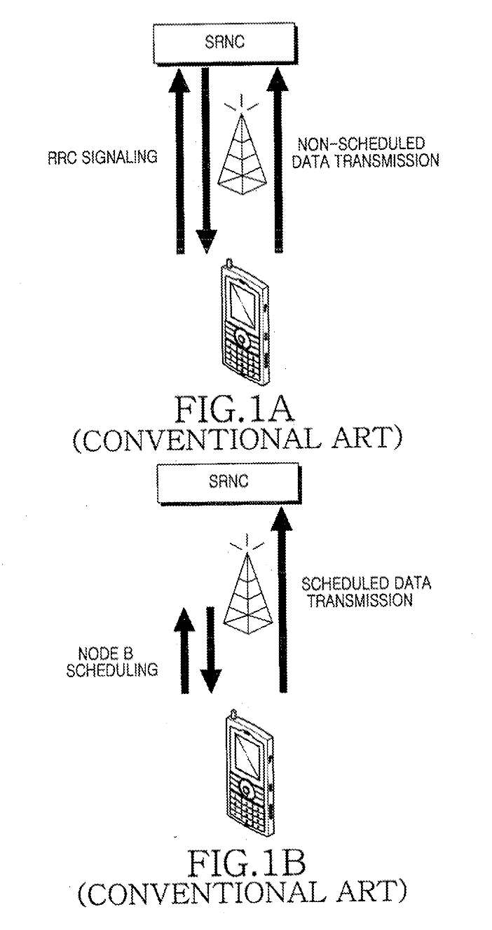

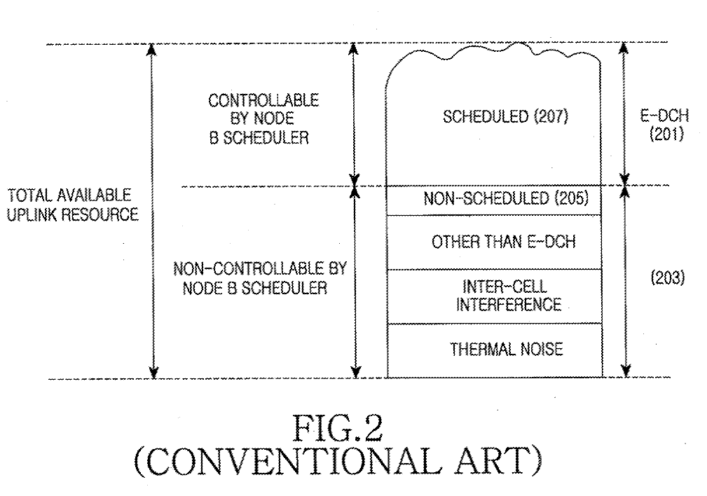

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions will be omitted for clarity and conciseness.

Exemplary embodiments of the present invention described below relate to a scheduling method and apparatus for supporting a variable data rate while ensuring a minimum data rate in order to provide a high speed video stream service in a communication system. Although the following description will be based on a High Speed Uplink Packet Access (HSUPA) system, the present invention is equally applicable to a High Speed Packet Access (HSPA) system and a Long Term Evolution (LTE) system.

Hereinafter, quasi-scheduled data transmission denotes a scheduling method for supporting a variable data rate while ensuring a minimum data rate. In the quasi-scheduled data transmission, the minimum data rate is guaranteed through Radio Resource Control (RRC) signaling from a Radio Network Controller (RNC), and the variable data rate is supported by using power allocated through scheduling of a Node B. Quasi-scheduled data denotes data scheduled using the quasi-scheduled data transmission.

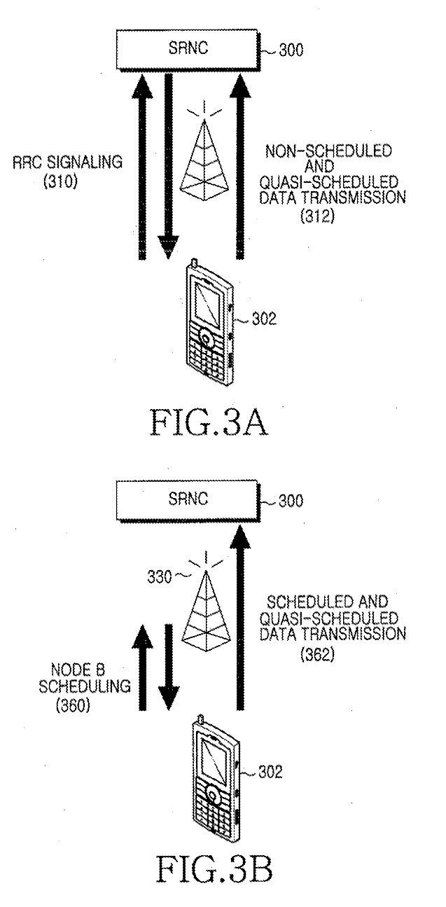

FIGS. 3A and 3B illustrate quasi-scheduled data transmission according to an exemplary embodiment of the present invention.

Referring to FIGS. 3A and 3B, quasi-scheduled data is controlled by a Serving Radio Network Controller (SRNC) 300 and a Node B 330. That is, the SRNC 300 controls transmission of non-scheduled data and quasi-scheduled data 312 through RRC signaling 310 as shown in FIG. 3A, and the Node B 330 controls transmission of scheduled data and quasi-scheduled data 362 through power allocated through a Node B scheduling 360 as shown in FIG. 3B.

To support the quasi-scheduled data transmission, the SRNC 300 classifies logical channels to be scheduled with the quasi-scheduled data and determines priorities of the classified logical channels. In this case, the SRNC 300 assigns a highest priority to a logical channel to be scheduled with the non-scheduled data, assigns a second highest priority to a logical channel to be scheduled with the quasi-scheduled data, and assigns a lowest priority to a logical channel to be scheduled with the scheduled data.

Further, to guarantee a minimum data rate for the quasi-scheduled data, the SRNC 300 informs a User Equipment (UE) 302 of a minimum data rate of a logical channel for the quasi-scheduled data through RRC signaling 310.

Table 1 below shows information transmitted for non-scheduled data and quasi-scheduled data by an RNC to a UE. The information is on an Enhanced Uplink Dedicated CHannel (E-DCH) Media Access Control-data (MAC-d) flow.

TABLE 1

| Information | | | | | |
|---|---|---|---|---|---|
| Element/Group | | | Type and | | |
| name | Need | Multi | reference | Semantics description | Version |
| E-DCH MAC-dflow | MP | | E-DCH MAC-d flow | | REL-6 |
| identity | | | identity 10.3.5.7s | | |
| E-DCH MAC-d flow | OP | | Integer(0 . . . 6) | Only allowed to be absent when already | REL-6 |
| power offset | | | | defined for this E-DCH MAC-d flow, unit is | |
| | | | | dB | |
| E-DCH MAC-d flow | OP | | Integer (0 . . . 15) | Only allowed to be absent when already | REL-6 |
| maximum number of | | | | defined for this E-DCH MAC-d flow | |
| retransmissions | | | | | |
| E-DCH MAC-d flow | OP | | Bitstring (maxE- | Indicates, if this is the first MAC-d flow for | REL-6 |
| multiplexing list | | | DCHMACdFlow) | which PDUs are placed in the MAC-e PDU, | |
| | | | | the other MAC-d flows from which MAC-d | |
| | | | | PDUs are allowed to be included in the | |
| | | | | same MAC-e PDU. | |
| | | | | Bit 0 is for MAC-d flow 0, Bit 1 is for MAC- | |
| | | | | d flow 1, . . . | |
| | | | | Value ‘1’ for a bit means multiplexing is | |
| | | | | allowed. Bit 0 is the first/leftmost bit of the | |
| | | | | bit string. | |
| | | | | NOTE: The bit that corresponds to the | |
| | | | | MAC-d flow itself is ignored. | |
| CHOICE transmission | OP | | | Only allowed to be absent when already | REL-6 |
| grant type | | | | defined for this E-DCH MAC-d flow | |
| >Non-scheduled | | | | | REL-6 |
| transmission grant | | | | | |
| info | | | | | |
| >>Max MAC-e PDU | MP | | Integer (1 . . . 19982) | | REL-6 |
| contents size | | | | | |
| >>2ms non- | MD | | Bitstring (8) | MAC-d PDUs for this MAC-d flow are only | REL-6 |
| scheduled | | | | allowed to be transmitted in those | |
| transmission grant | | | | processes for which the bit is set to ‘1’. | |
| HARQ process | | | | Bit 0 corresponds to HARQ process 0, bit | |
| allocation | | | | 1 corresponds to HARQ process 1, . . . | |
| | | | | Default value is: transmission in all HARQ | |
| | | | | processes is allowed. Bit 0 is the | |
| | | | | first/leftmost bit of the bit string. | |
| >Quasi-scheduled | | | | | REL-6 |
| transmission grant | | | | | |
| info | | | | | |
| >>Guaranteed MAC- | MP | | Integer (1 . . . 19982) | | REL-6 |
| e PDU contents size | | | | | |
| >>2ms quasi- | MD | | Bitstring (8) | MAC-d PDUs for this MAC-d flow are only | |
| scheduled | | | | allowed to be transmitted in those | |
| transmission grant | | | | processes for which the bit is set to ‘1’. | |
| HARQ process | | | | Bit 0 corresponds to HARQ process 0, bit | |
| allocation | | | | 1 corresponds to HARQ process 1. | |
| | | | | Default value is: transmission in all HARQ | |
| | | | | processes is allowed. Bit 0 is the | |
| | | | | first/leftmost bit of the bit string. | |
| >Scheduled | | | NULL | | REL-6 |
| transmission grant | | | | | |
| info | | | | | |

As shown in Table 1 above, information transmitted by the RNC to a UE through RRC signaling further includes information on the quasi-scheduled data of an exemplary embodiment of the present invention. In Table 1 above, “Guaranteed MAC-e PDU contents size” denotes a minimum MAC-enhanced (MAC-e) PDU size of quasi-scheduled data, wherein the minimum AMC-e PDU size is guaranteed for the UE by a network. The term “2 ms quasi-scheduled transmission grant HARQ process allocation” denotes an IDentifier (ID) of a Hybrid Automatic Retransmission Request (HARQ) process for managing transmission of quasi-scheduled data when a Transmission Time Interval (TTI) is 2 ms. Table 1 above is created based on the R′6 of the HSPA, and may vary when the HSPA evolution system or the LTE system is used.

As illustrated in FIG. 3B, for the transmitted scheduled data and the quasi-scheduled data 362, the Node B 330 allocates Serving Grant (SG) information indicating a power allocation to a UE 302 through a Node B scheduling 360 communicated in a control signal channel.

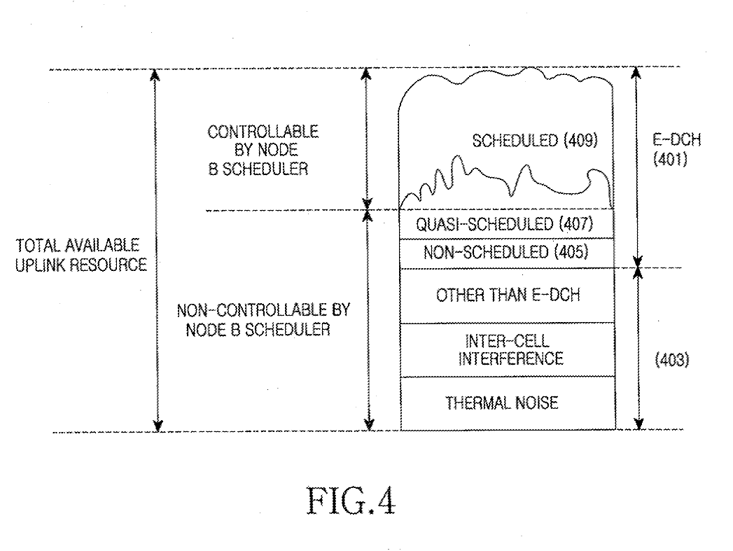

The UE 302 may transmit the non-scheduled data, the quasi-scheduled data, and the scheduled data to the Node B 330 by multiplexing or by using a different HARQ process in every TTI. In this case, similar to the conventional non-scheduled data, an amount of data determined through RRC signaling and with the guaranteed minimum data rate among the quasi-scheduled data is transmitted in every TTI. When an SG value capable of transmitting scheduled data is allocated to the TTI, the scheduled data is allocated with a power resource remaining after allocating the quasi-scheduled data. That is, as illustrated in FIG. 4, the scheduled data is transmitted using a power resource 409 remaining after excluding a power resource 403 for channels other than an E-DCH 401, a power resource 405 for the non-scheduled data, and a power resource 407 for quasi-scheduled data.

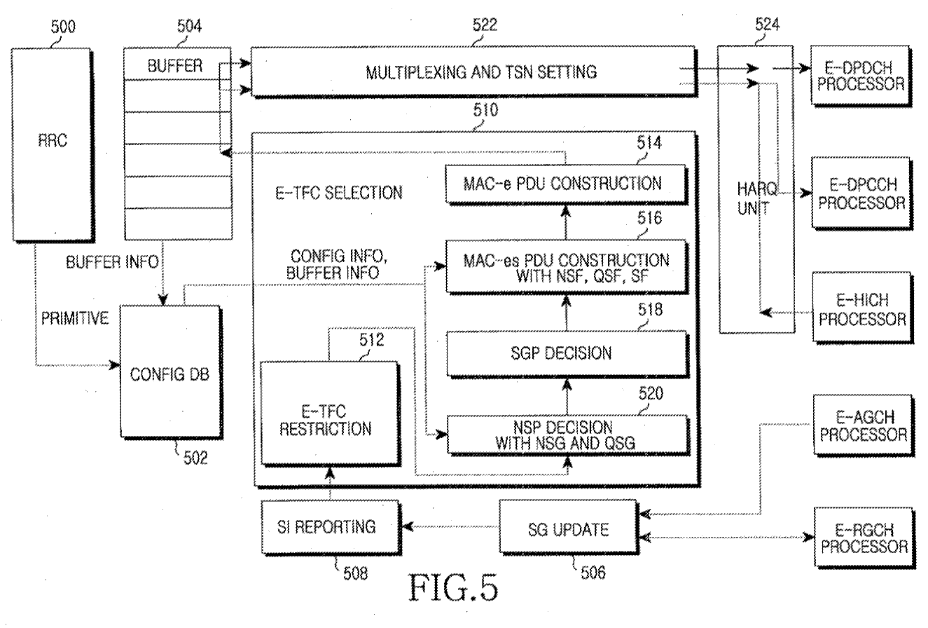

FIG. 5 is a block diagram illustrating a UE supporting quasi-scheduled data transmission in a HSUPA system according to an exemplary embodiment of the present invention.

Referring to FIG. 5, the UE includes a Radio Resource controller (RRC) 500, a config-DataBase (config-DB) 502, a buffer 504, a Serving Grant (SG) update unit 506, a Scheduling Information (SI) reporting unit 508, an Enhanced-Transport Format Combination (E-TFC) selection unit 5 10, a multiplexing/Transmission Sequence Number (TSN) setting unit 522, and a Hybrid Automatic Retransmission Request (HARQ) unit 524. The E-TFC selection unit 510 includes an E-TFC restriction unit 512, a MAC-e PDU construction unit 514, a MAC-enhanced service(MAC-es) PDU construction unit 516, a Scheduled Grant Payload (SGP) decision unit 518, and a Non-Scheduled Payload (NSP) decision unit 520.

The RRC 500 receives primitive information from an SRNC through RRC signaling and provides the received primitive information to the config-DB 502. Further, the RRC 500 may receive Scheduling Information (SI) from a Node B and transmits the received SI to the config-DB 502.

The config-DB 502 stores the primitive information provided from the RRC 500. Further, the config-DB 502 receives information on data stored in the buffer 504 from the buffer 504 and then stores the information.

The SG update unit 506 calculates a power level to be used for transmission of scheduled data at a TTI by using the control signal channel's SG information received from the Node B. Then, the SG update unit 506 provides the calculated power level to the SI reporting unit 508. The SG information denotes information on power allocated by the Node B to each UE for scheduled data.

The SI reporting unit 508 determines whether SI has to be transmitted at a current TTI and then provides the determination result to the E-TFC restriction unit 512.

As described above, the E-TFC selection unit 510 includes the E-TFC restriction unit 512, the MAC-e PDU construction unit 514, the MAC-es PDU construction unit 516, the SGP decision unit 518, and the NSP decision unit 520. Accordingly, the E-TFC selection unit 510 selects a Transport Format Combination (TFC) suitable for a channel condition.

The E-TFC restriction unit 512 determines a maximum payload size transmittable at the current TTI and then provides the determined maximum payload size to the NSP decision unit 520.

By using information provided from the config-DB 502, for each MAC-d flow, the NSP decision unit 520 calculates a size of non-scheduled data to be transmitted at the current TTI and a minimum quasi-scheduled data size to be guaranteed. Thereafter, the NSP decision unit 520 calculates a sum of the data sizes determined for all MAC-d flows and determines the sum as a Non-Scheduled Payload (NSP) size. The non-scheduled data size determined through signaling and the quasi-scheduled data size are respectively referred to as a Non-Scheduled Grant (NSG) and a Quasi-Scheduled Grant (QSG).

The SGP decision unit 518 calculates sizes of remaining payloads by subtracting the NSP size calculated by the NSP decision unit 520 and an SI size from the minimum payload size determined by the E-TFC restriction unit 512. Then, the SGP decision unit 518 determines a size of scheduled data to be transmitted at the current TTI by using the calculated payload size and the SG information. The scheduled data size is referred to as a Scheduled Grant Payload (SGP).

The MAC-es PDU construction unit 516 receives buffer information on a type and size of data currently stacked in the buffer 504 from the config-DB 502. Then, the MAC-es PDU construction unit 516 determines types of MAC-d flows (i.e., non-scheduled MAC-d flow, quasi-scheduled MAC-d flow, and scheduled MAC-d flow) to be transmitted at the current TTI according to configuration information of each MAC-d flow. When the type of the MAC-d flow is determined, the MAC-es PDU construction unit 516 determines a data size of the MAC-d flow. As for the non-scheduled data size, only a size determined through RRC signaling is assigned. As for the scheduled data size, a minimum payload size guaranteed through the RRC signaling is first assigned and then the scheduled data size variable within a range of an SG value is assigned. The SG value is SI of the Node B. Remaining parts within the range of the SG value are assigned for the scheduled data.

The MAC-e PDU construction unit 514 determines an E-TFC by considering SI and padding, and then informs the buffer 504 of information on data determined to be transmitted.

The buffer 504 evaluates the data information received from the MAC-e PDU construction unit 514 and provides corresponding data stored in the buffer 504 to the multiplexing/TSN setting unit 522.

The multiplexing/TSN setting unit 522 creates a MAC-es PDU by adding a TSN into data provided from the buffer 504. Then, the multiplexing/TSN setting unit 522 constructs a MAC-e PDU by multiplexing the MAC-es PDU with the MAC-e PDU and by adding each header, SI, and padding. Then, the multiplexing/TSN setting unit 522 transmits the constructed MAC-e PDU to the HARQ unit 524 for data transmission.

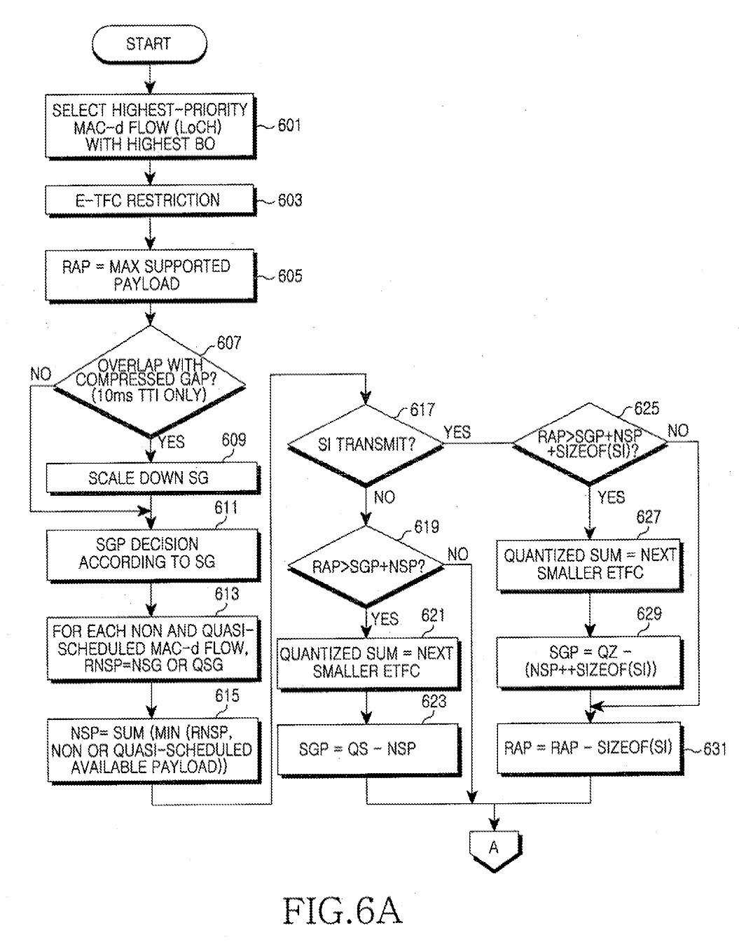

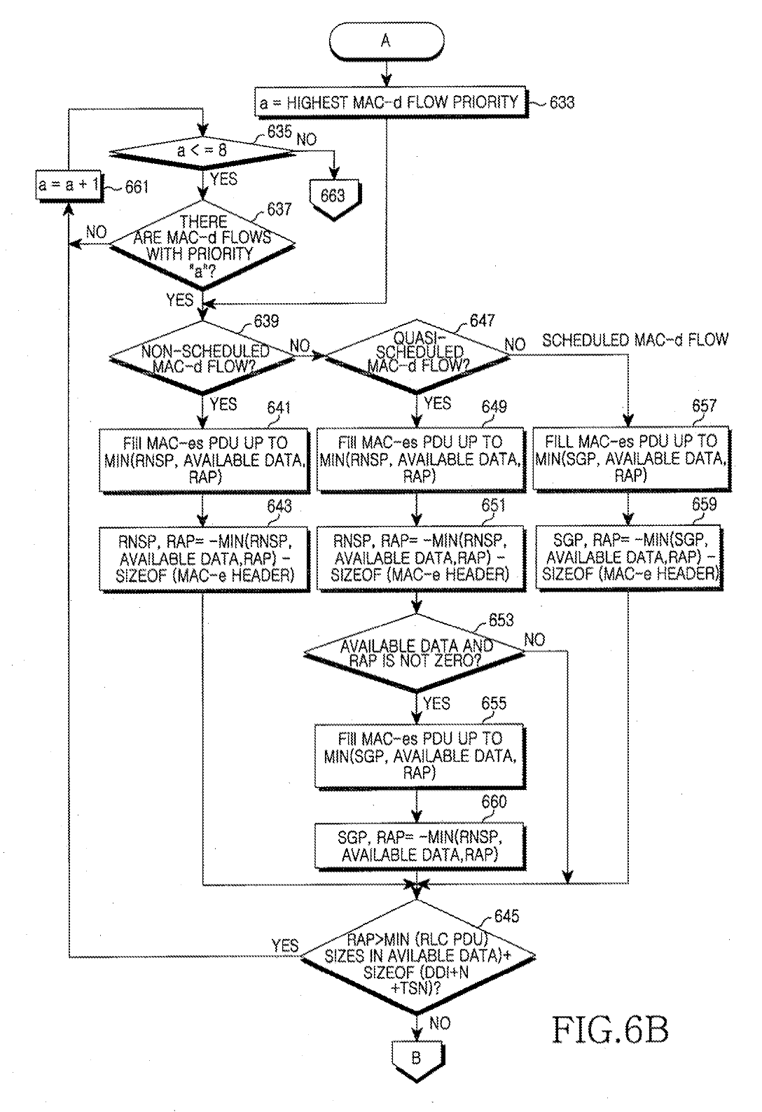

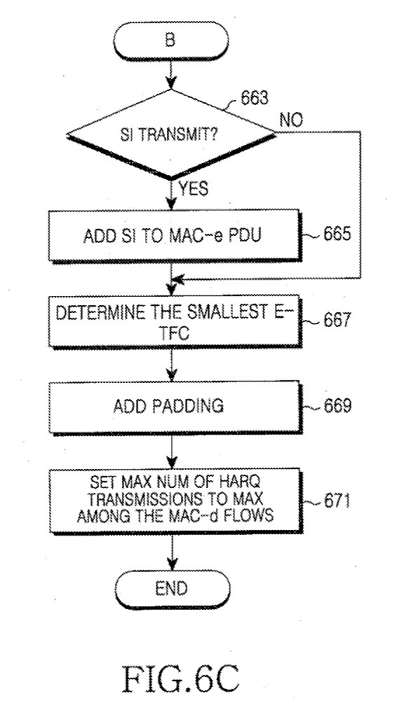

FIGS. 6A, 6B, and 6C are flowcharts illustrating an operation of a UE supporting quasi-scheduled data transmission in a HSUPA system according to an exemplary embodiment of the present invention.

Referring to FIGS. 6A, 6B, and 6C, the UE selects a MAC-d flow of a logical channel having a highest priority in step 601, and then determines a maximum payload size transmittable at a current TTI in step 603.

In step 605, the UE determines the maximum payload size as a Remaining Available Payload (RAP). In step 607, the UE determines whether there is a partially overlapping portion in a compressed gap. If there is no partially overlapping portion, the procedure proceeds to step 611. Otherwise, if there is a partially overlapping portion, the UE decreases an SG size in step 609, and the procedure proceeds to step 611.

In step 611, the UE determines a Scheduled Grant Payload (SGP) for scheduled data to be transmitted at a current TTI according to the SG. The SGP may be determined in such a manner that a NSP size and an SI size are subtracted from the maximum payload size (i.e., the RAP) to calculate a remaining payload size and thereafter the SGP is determined using the calculated payload size and SG information.

In step 613, for each MAC-d flows, the UE calculates a size of non-scheduled data (i.e., NSG) to be transmitted at the current TTI and a minimum quasi-scheduled data size (i.e., QSG) to be guaranteed, and thereafter determines a Remaining Non-Scheduled Payload (RNSP) size by summing the data sizes determined for all MAC-d flows.

In step 615, the UE calculates minimum sizes of the RNSP and the non or quasi-scheduled available payloads, and determines a NSP size by summing the minimum sizes.

In step 617, the UE determines whether SI has to be transmitted at the current TTI. If the SI is not transmitted, the UE compares the RAP with a sum of the SGP and the NAP in step 619.

If the sum of the SGP and the NSP is greater than or equal to the RAP, the procedure proceeds to step 633. Otherwise, if the sum of the SGP and the NSP is less than the RAP, the UE calculates a quantized value by summing the NSP and a second smallest SGP supported by an E-TFC in step 621. In step 623, the UE subtracts the NSP from the quantized value and determines the resultant value as the SGP. Then, the procedure proceeds to step 633.

If the SI is determined to be transmitted at the current TTI in step 617, the UE compares the RAP with a sum of the determined SGP, the NSP, and the SI size in step 625.

If the sum of the SGP, the NSP, and the SI size is greater than or equal to the RAP, the process proceeds to step 631. Otherwise, if the sum of the SGP, the NSP, and the SI size is less than the RAP, the UE calculates a quantized value by summing the NSP, and the SI size, and the second smallest SGP supported by the E-TGC in step 627. In step 629, the UE subtracts the NSP and the SI size from the quantized value and determines the resultant value as the SGP. Then, the procedure proceeds to step 631.

In step 631, the UE subtracts the SI size from the RAP and determines the resultant value as the RAP. Then, the procedure proceeds to step 633.

In step 633, the UE selects a MAC-d flow of a logical channel having a highest priority. In step 639, the UE determines whether the selected MAC-d flow is a non-scheduled MAC-d flow. If the selected MAC-d flow is the non-scheduled MAC-d flow, the UE constructs the MAC-e PDU with minimum amounts of the RNSP, data available in the logical channel, and the RNP in step 641. In step 643, the UE subtracts the minimum data amounts used to constitute the MAC-d PDU and a size of a MAC-e header from the size of the RNSP and the size of the RNP. Thereafter, the procedure proceeds to step 645.

Returning to step 639, if the selected MAC-d flow is not the non-scheduled MAC-d flow, the UE determines whether the selected MAC-d flow is quasi-scheduled MAC-d flow in step 647. If the selected MAC-d flow is the quasi-scheduled MAC-d flow, the UE constructs the MAC-e PDU with minimum amounts of the RNSP, data available in the logical channel, and the RNP in step 649. In step 651, the UE subtracts the minimum data amounts used to constitute the MAC-d PDU and the size of the MAC-e header from the size of the RNSP and the size of the RNP.

In step 653, the UE determines whether the available data and the RAP are zero in size. That is, the UE determines whether there are available data and the RAP remaining. If the available data and RAP are zero in size, the procedure proceeds to step 645. Otherwise, if the available data and the RAP are not zero, the UE constructs the MAC-e PDU by using minimum amounts of the SGP, the data available in the logical channel, and the RNP in step 655. In step 660, the UE subtracts the minimum data amounts used to constitute the MAC-d PDU from the size of the RNSP and the size of the RNP. Thereafter, the procedure proceeds to step 645.

Returning to step 647, if the selected MAC-d flow is not the quasi-scheduled MAC-d flow, the UE determines that the MAC-d flow is a scheduled MAC-d flow, and in step 657, constructs the MAC-e PDU by using minimum amounts of the SGP, the data available in the logical channel, and the RAP. In step 659, the UE subtracts the minimum data amounts used to constitute the MAC-d PDU and the size of the MAC-e header from the size of the SGP and the size of the RAP. Thereafter, the procedure proceeds to step 645.

In step 645, the UE determines whether a sum of a minimum size of an RLC PDU in the available data and a size of Data Description Indicator (DDI), Number of MAC-d PDUs (N), and TSN is greater than the RAP.

If the RAP is greater than the sum, the UE increments the priority by 1 in step 661. In step 635, the UE determines whether the priority is less than or equal to 8. If the priority is greater than 8, the procedure proceeds to step 663. Otherwise, if the priority is less than or equal to 8, the UE determines whether a MAC-d flow having the increased priority exists in step 637. If the MAC-d flow having the increased priority exists, the procedure proceeds to step 639. Otherwise, if the MAC-d flow having the increased priority does not exist, the procedure returns to step 661.

In step 663, the UE determines whether SI is transmitted at the current TTI. If the SI is not transmitted at the current TTI, the procedure proceeds to step 667. Otherwise, if the SI is transmitted at the current TTI, the UE adds the SI to the constructed MAC-d PDU in step 665. In step 667, the UE determines a minimum E-TFC size supporting the MAC-d PDU. In step 669, the UE adds padding if necessary by comparing the MAC-d PDU with the minimum E-TFC size. In step 671, the UE transmits the constructed MAC-d PDU according to a HARQ process.

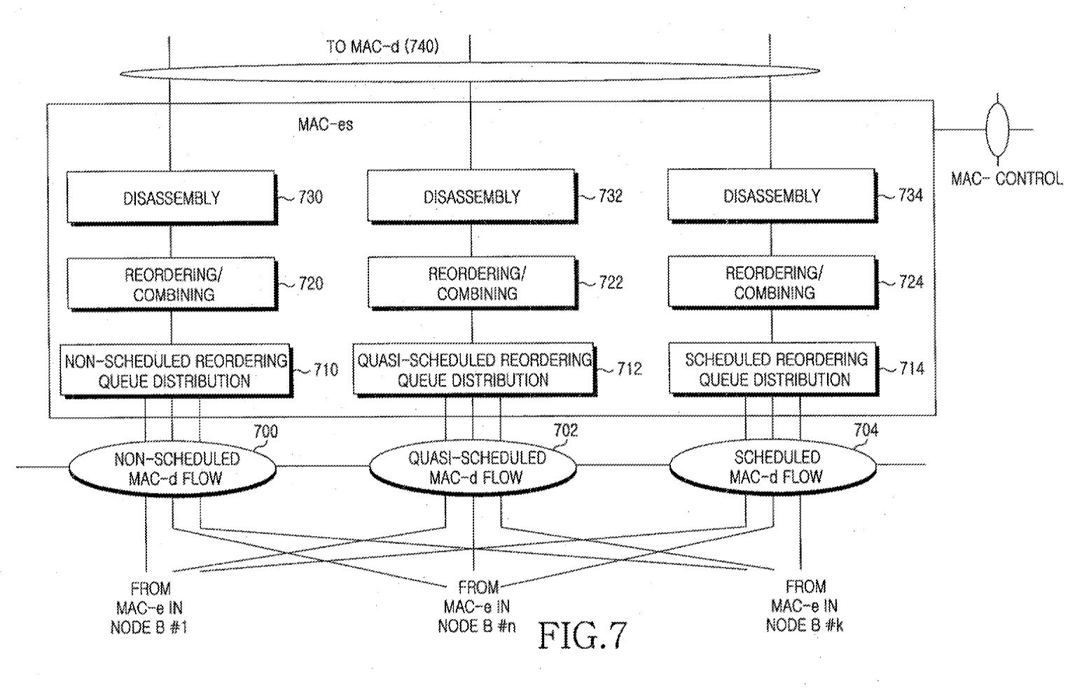

FIG. 7 is a block diagram of an RNC supporting quasi-scheduled data transmission in a HSUPA system according to an exemplary embodiment of the present invention. Herein, MAC-es PDUs received from a Node B are transmitted by the RNC to a MAC-d layer.

Referring to FIG. 7, to process MAC-es PDUs, the RNC includes reordering queue distribution blocks 710, 712, and 714, reordering/combining blocks 720, 722, and 724, and disassembly blocks 730, 732, and 734. Each block can be classified into a block for processing conventional non-scheduled data and scheduled data and a block for processing quasi-scheduled data of an exemplary embodiment of the present invention.

The reordering queue distribution blocks 710, 712, and 714 are respectively a non-scheduled reordering queue distribution block 710, a quasi-scheduled reordering queue distribution block 712, and a scheduled reordering queue distribution block 714. The reordering queue distribution blocks 710, 712, and 714 receive MAC-e PDUs by using macro diversity and determine which MAC-d flow 700, 702 and 704 and priority the received PDUs belong to. Then, the reordering queue distribution blocks 710, 712, and 714 transmit the PDUs to reordering/combining blocks indicated by corresponding MAC-d flow IDs.

The reordering/combining blocks 720, 722, and 724 are classified into three blocks for processing respective data, and regulate parameters by considering a service type of a MAC-d flow that is input according to the MAC-d flow. Thus, the reordering/combining blocks 720, 722, and 724 perform functions for providing a Quality of Service (QoS). That is, the reordering/combining blocks 720, 722, and 724 perform reordering so that non-sequentially received MAC-e PDUs can be sequentially delivered to an upper layer.

The disassembly blocks 730, 732, and 734 disassemble the MAC-e PDUs delivered from the reordering/combining blocks 720, 722, and 724 and thus reconstruct the MAC-e PDUs into MAC-d PDUs. Then, the disassembly blocks 730, 732, and 734 transmit the MAC-d PDUs to corresponding entities of the MAC-d layer 740.

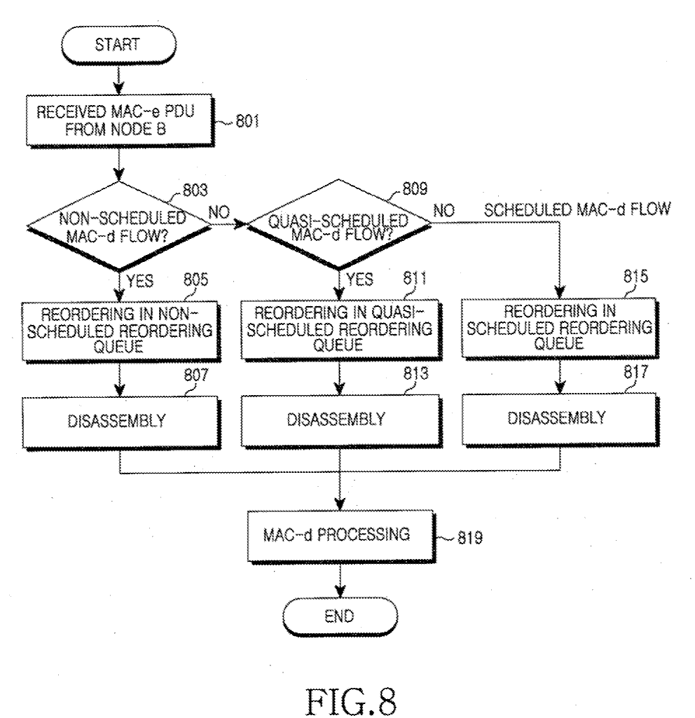

FIG. 8 is a flowchart illustrating an operation of an RNC supporting quasi-scheduled data transmission in a HSUPA system according to an exemplary embodiment of the present invention.

Referring to FIG. 8, the RNC receives a MAC-e PDU from a Node B in step 801, and then determines whether a MAC-d flow of the received MAC-e PDU is a non-scheduled MAC-d flow in step 803.

If the MAC-d flow of the received MAC-e PDU is the non-scheduled MAC-d flow, the RNC sequentially reorders the MAC-e PDU by using a non-scheduled reordering queue that manages the non-scheduled data in step 805. Then, in step 807, the RNC disassembles the MAC-e PDU and reconstructs it into a MAC-d PDU. In step 819, the RNC restores a MAC-d Service Data Unit (SDU) and delivers the MAC-d SDU to an upper layer. Thereafter, the procedure of the FIG. 8 ends.

Returning to step 803, if the MAC-d flow of the received MAC-e PDU is not the non-scheduled MAC-d flow, the RNC determines whether the MAC-d flow of the received MAC-e PDU is a quasi-scheduled MAC-d flow in step 809. If the MAC-d flow of the received MAC-e PDU is the quasi-scheduled MAC-d flow, the RNC sequentially reorders the MAC-e PDU by using a non-scheduled reordering queue that manages the non-scheduled data in step 811. Then, in step 813, the RNC disassembles the MAC-e PDU and reconstructs it into a MAC-d PDU. In step 819, the RNC restores the MAC-d SDU and delivers the MAC-d SDU to the upper layer. Thereafter, the procedure of the FIG. 8 ends.

Otherwise, in step 809, if the MAC-d flow of the received MAC-e PDU is not the quasi-scheduled MAC-d flow, the RNC determines that the MAC-d flow of the received MAC-e PDU is a scheduled MAC-d flow, and sequentially reorders the MAC-e PDU by using a non-scheduled reordering queue that manages the non-scheduled data in step 815. Then, in step 817, the RNC disassembles the MAC-e PDU and reconstructs it into a MAC-d PDU. In step 819, the RNC restores the MAC-d SDU and delivers the MAC-d SDU to the upper layer. Thereafter, the procedure of the FIG. 8 ends.

As described above, when quasi-scheduled data is processed by the RNC and the UE, the quasi-scheduled data can be processed with a simple software update without having a significant effect on an existing system. In addition, when a TFC suitable for a channel condition is selected, a processing time is not significantly increased in comparison with the conventional case.

According to exemplary embodiments of the present invention, a scheduling method is provided in which a variable data rate is supported while ensuring a minimum data rate in order to provide a high speed video stream service in a communication system. Since reasonable scheduling can be provided for a high speed video stream service in a 3G wireless communication system, there is an advantage in that data processing is possible with a simple software update when using a conventional UE and a conventional network.

While the present invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the invention is defined not by the detailed description of the exemplary embodiments of the invention but by the appended claims and their equivalents, and all differences within the scope will be construed as being included in the present invention.

What is claimed is:

1. A scheduling method of a User Equipment (UE) for providing a high speed video stream service in a communication system, the method comprising:
receiving power information for ensuring a minimum data rate from a Radio Network Controller (RNC) through Radio Resource Control (RRC) signaling;
receiving power information for a variable data rate from a Node B through scheduling; and
performing a high speed video stream service on the basis of the power information received from the RNC and the Node B.

2. The method of claim 1, wherein the receiving of the power information from the RNC comprises:
receiving a non-scheduled grant; and
receiving a quasi-scheduled grant for the high speed video stream service.

3. The method of claim 2, wherein the quasi-scheduled grant information comprises at least one of a minimum Media Access Control-enhanced Protocol Data Unit (MAC-e PDU) size guaranteed by a network and an IDentifier (ID) of a Hybrid Automatic Retransmission Request (HARQ) process for managing transmission of the quasi-scheduled data.

4. The method of claim 1, wherein, when the power information is received from the Node B, power is first allocated to the quasi-scheduled data for the high speed video stream service and then remaining power is allocated to the scheduled data.

5. The method of claim 1, wherein the performing of the high speed video stream service on the basis of the power information received from the RNC and the Node B comprises:
determining a maximum payload size transmittable at a current Transmission Time Interval (TTI);
calculating, for each MAC-data (MAC-d) flow, a non-scheduled payload size by using a size of non-scheduled data to be transmitted at the current TTI and a minimum quasi-scheduled data size;
calculating a size of scheduled data to be transmitted at the current TTI by subtracting the non-scheduled payload size and scheduling information from the maximum payload size; and
constructing a MAC-e PDU by using the calculated non-scheduled payload and scheduled data sizes according to a type of each MAC-d flow.

6. The method of claim 5, wherein the constructing of the MAC-e PDU by using the calculated non-scheduled payload and scheduled data sizes according to the type of each MAC-d flow comprises:
if the MAC-d flow is a quasi-scheduled flow, assigning a minimum payload size guaranteed through RRC signaling to the quasi-scheduled data; and
assigning a data size variable within a range of a serving grant value that is scheduling information of the Node B to the quasi-scheduled data.

7. The method of claim 5, further comprising:
after assigning the minimum payload size to the quasi-scheduled data, determining whether available data and a Remaining Available Payload (RAP) are remaining; and
if there is the available data and the RAP remaining, assigning the data size variable within the range of the serving grant value to the scheduled data.

8. The method of claim 5, wherein the calculating of the non-scheduled payload comprises:
calculating, for each MAC-d flow, a size of a remaining non-scheduled payload by summing the size of the non-scheduled data to be transmitted at the current TTI and a minimum quasi-scheduled data size to be guaranteed; and
calculating a size of the non-scheduled payload by summing the size of the remaining non-scheduled payload and a size of a non-scheduled or quasi-scheduled remaining payload.

9. The method of claim 1, wherein the scheduling is communicated in a control channel.

10. A scheduling apparatus of a User Equipment (UE) for providing a high speed video stream service in a communication system, the apparatus comprising:
a receiver for receiving power information for ensuring a minimum data rate from a Radio Network Controller (RNC) through Radio Resource Control (RRC) signaling and for receiving power information for a variable data rate from a Node B through scheduling; and
an Enhanced-Transport Format Combination (E-TFC) selector for selecting a Transport Format Combination (TFC) for a high speed video stream service on the basis of the power information received from the RNC and the Node B.

11. The apparatus of claim 10, wherein the power information received from the RNC comprises grant information on non-scheduled data and grant information on quasi-scheduled data for the high speed video stream service.

12. The apparatus of claim 11, wherein the quasi-scheduled grant information comprises at least one of a minimum Media Access Control-enhanced Protocol Data Unit (MAC-e PDU) size guaranteed by a network and an IDentifier (ID) of a Hybrid Automatic Retransmission Request (HARQ) process for managing transmission of the quasi-scheduled data.

13. The apparatus of claim 10, wherein, when the power information is received from the Node B through scheduling, power is first allocated to the quasi-scheduled data for the high speed video stream service and then remaining power is allocated to the scheduled data.

14. The apparatus of claim 10, wherein the E-TFC selector comprises:
an E-TFC restriction unit for determining a maximum payload size transmittable at a current Transmission Time Interval (TTI);
a non-scheduled payload decision unit for calculating, for each MAC-data (MAC-d) flow, a non-scheduled payload size by using a size of non-scheduled data to be transmitted at the current TTI and a minimum quasi-scheduled data size;
a scheduled data size decision unit for calculating a size of scheduled data to be transmitted at the current TTI by subtracting the non-scheduled payload size and scheduling information from the maximum payload size; and
a MAC-e PDU construction unit for constructing a MAC-e PDU by using the calculated non-scheduled payload and scheduled data sizes according to a type of each MAC-d flow.

15. The apparatus of claim 14, wherein, if the MAC-d flow is a quasi-scheduled flow, the MAC-e PDU construction unit assigns a minimum payload size guaranteed through RRC signaling to the quasi-scheduled data and assigns a data size variable within a range of a serving grant value that is scheduling information of the Node B to the quasi-scheduled data.

16. The apparatus of claim 14, wherein, after assigning the minimum payload size to the quasi-scheduled data, the MAC-e PDU construction unit determines whether available data and a Remaining Available Payload (RAP) are remaining, and if there is the available data and the RAP remaining, assigns the data size variable within the range of the serving grant value to the scheduled data.

17. The apparatus of claim 14, wherein the non-scheduled payload decision unit calculates, for each MAC-d flow, a size of a remaining non-scheduled payload by summing the size of the non-scheduled data to be transmitted at the current TTI and a minimum quasi-scheduled data size to be guaranteed, and calculates a size of the non-scheduled payload by summing the size of the remaining non-scheduled payload and a size of a non-scheduled or quasi-scheduled remaining payload.

18. The apparatus of claim 10, wherein the scheduling is communicated in a control channel.
